(19) United States
(12) Patent Application Publication
(10) Pub. No.: US 2015/0275928 A1
(43) Pub. Date: Oct. 1, 2015

(54) PUMP APPARATUS AND HYDRAULIC ACTUATOR

(71) Applicant: SHOWA CORPORATION, Gyoda-shi (JP)

(72) Inventors: Hayato TSUTSUI, Haga-gun (JP); Kazuhiko SADAKATA, Haga-gun (JP); Atsushi KAGAWA, Haga-gun (JP)

(73) Assignee: SHOWA CORPORATION, Gyoda-shi (JP)

(21) Appl. No.: 14/491,075

(22) Filed: Sep. 19, 2014

(30) Foreign Application Priority Data
Mar. 25, 2014 (JP) 2014-062718

(51) Int. Cl. F15B 11/024; F04B 5/02; F04B 53/10

(52) U.S. Cl. CPC F15B 11/024; F04B 53/10; F04B 5/02; F15B 2211/7052; F15B 2211/50554; F15B 2211/511; F15B 2211/565; F15B 2211/30; F15B 2211/205

(57) ABSTRACT

A pump apparatus includes: a pump that ejects a hydraulic fluid; and a selector valve that switches a direction of a flow of the hydraulic fluid to be supplied to one of a first chamber and a second chamber into which a cylinder apparatus is internally partitioned by a piston, the first chamber extending during a stroke of the piston for extending the cylinder apparatus, and the second chamber extending during a stroke of the piston for shortening the cylinder apparatus, and the selective valve has, at a channel connected to the second chamber, an orifice that is narrower than a channel connected to the first chamber.

### CROSS-REFERENCE TO RELATED APPLICATIONS

This application is based on and claims priority under 35 U.S.C. 119 from Japanese Patent Application No. 2014-062718 filed on Mar. 25, 2014, the entire content of which is incorporated herein by reference.

### BACKGROUND OF THE INVENTION

1. Field of the Invention

The present invention relates to a pump apparatus and a hydraulic actuator.

2. Description of the Related Art

A hydraulic actuator used to, for example, change the inclination of an outboard motor with respect to a hull is provided with a selector valve in a channel between a pump and a cylinder apparatus internally partitioned into a lower chamber (first chamber) and an upper chamber (second chamber) by the piston; the selector valve directs a flow of a hydraulic fluid to the lower chamber or the upper chamber in a switchable manner. The selector valve includes an open valve located on a side of the selector valve which leads to the lower chamber and an open valve located on a side of the selector valve which leads to the upper chamber; the open valves are interlocked with each other. Each of the open valves is a combination of an actuation valve and a check valve which slide in a valve chamber.

The selector valve operates as follows. When a hydraulic fluid flows into a valve chamber for the open valve located on the side of the selector valve which leads to the lower chamber, the lower chamber-side check valve is opened under the pressure of the hydraulic fluid to cause the hydraulic fluid to flow to the lower chamber. In parallel with the operation of the check valve, the lower chamber-side actuation valve pressed by the inflow of the hydraulic fluid is displaced inside the valve chamber. The pressure of the displaced actuation valve displaces, via a communication path, the actuation valve in the open valve located on the side of the selector valve which leads to the upper chamber. Then, the displaced upper chamber-side actuation valve pushes and opens the upper chamber-side check valve to return the hydraulic fluid from the upper chamber to the pump. This operation extends the shortened cylinder apparatus to increase the inclination of the outboard motor.

On the other hand, when the hydraulic fluid flows into the valve chamber for the open valve located on a side of the selector valve which leads to the upper chamber, an operation opposite to the above-described operation is performed to feed the hydraulic fluid to the upper chamber, while returning the hydraulic fluid from the lower chamber to the pump. This operation shortens the extended cylinder apparatus to reduce the inclination of the outboard motor.

If the outboard motor has a weight larger than an expected value or air is mixed into a channel between the upper chamber in the cylinder apparatus and the check valve located on the side of the selector valve which leads to the upper chamber, when the tilted-up outboard motor is lowered, the outboard motor may move jerkily. This is because, as the cylinder apparatus shortens, the pressure in the above-described channel lowers excessively to prevent the upper chamber-side actuation valve from maintaining a displaced state, causing the check valve located on the side leading to the lower chamber to be repeatedly opened and closed.

Thus, to restrain this jerky motion, a narrowed orifice is provided in the channel (see, for example, Japanese Patent Application Laid-open No. H9-11987).

The above-described channel is formed in a manifold (housing) via which the pump and the cylinder apparatus are connected together, and thus, a machining operation needs to be performed on the manifold in order to form the narrowed orifice.

With the foregoing in view, it is an object of the present invention to provide a pump apparatus and a hydraulic actuator which allows jerky motion of the hydraulic actuator to be suppressed without the need to add a machining operation for providing a narrowed orifice.

### SUMMARY OF THE INVENTION

The present invention is a pump apparatus integrally including: a pump that ejects a hydraulic fluid; and a selector valve that switches a direction of a flow of the hydraulic fluid to be supplied to one of a first chamber and a second chamber into which a cylinder apparatus is internally partitioned by a piston, the first chamber extending during a stroke of the piston for extending the cylinder apparatus, and the second chamber extending during a stroke of the piston for shortening the cylinder apparatus, wherein the selective valve has, at a channel connected to the second chamber, an orifice that is narrower than a channel connected to the first chamber. In the pump apparatus according to the present invention, the selector valve includes an actuation valve and a check valve. The orifice may be formed as a part of a channel between the actuation valve and the check valve.

In the pump apparatus according to the present invention, a case housing the pump may include a first case and a second case which are laid on top of each other, the first case may include a check valve chamber in which a main body of the check valve is housed, the second case may include an actuation valve chamber in which a main body of the actuation valve is housed, and the orifice may be formed as a part of a channel through which the check valve chamber and the actuation valve chamber communicate with each other.

The present invention is a hydraulic actuator including a cylinder apparatus internally partitioned by a piston into a first chamber extending during a stroke of the piston for extending the cylinder apparatus and a second chamber extending during a stroke of the piston for shortening the cylinder apparatus, and a pump apparatus integrally having a pump that ejects a hydraulic fluid and a selector valve that switches a direction of a flow of the hydraulic fluid to be supplied to one of the first chamber and the second chamber, the selective valve comprising, at a channel connected to the second chamber, an orifice that is narrower than a channel connected to the first chamber.

The pump apparatus according to the present invention allows jerky motion of the hydraulic actuator to be suppressed without the need to add a machining operation for providing the orifice.

The hydraulic actuator according to the present invention can be restrained from moving jerkily without the need to add a machining operation for providing the orifice.

### BRIEF DESCRIPTION OF THE DRAWINGS

FIG. 1 is a perspective view showing the appearance of a trim/tilt apparatus including a pump apparatus according to an embodiment of the present invention;

FIG. 2 is a cross-sectional view of an important part of the trim/tilt apparatus;

FIG. 3 is a perspective view showing a housing and a cylinder of the trim/tilt apparatus;

FIG. 4 is a schematic diagram showing arrangement of a hull and a ship propulsion machine for which the trim/tilt apparatus is used, as viewed from a side of the trim/tilt apparatus;

FIG. 5 is a diagram showing a hydraulic circuit for the trim/tilt apparatus;

FIG. 6 is a diagram showing the appearance of the pump apparatus;

FIG. 7 is an exploded perspective view showing that the pump apparatus has been disassembled into components;

FIG. 8 is a cross-sectional view taken along a line VIII-VIII in FIG. 6 and showing a plane including an up blow valve and a down blow valve;

FIG. 9 is a cross-sectional view taken along line IX-IX in FIG. 6 and showing a plane including a first open valve, a second open valve, and a third relief valve of a selector valve;

FIG. 10A is a cross-sectional view showing an opening portion of a first check valve chamber, and FIG. 10B is a cross-sectional view showing an opening portion of a second check valve chamber; and

FIG. 11A is a cross-sectional view showing an opening portion of a first check valve chamber in a pump apparatus and a trim/tilt apparatus according to Embodiment 2, and FIG. 11B is a cross-sectional view showing an opening portion of a second check valve chamber in the pump apparatus and the trim/tilt apparatus according to Embodiment 2.

### EXPLANATION OF REFERENCE NUMERALS

22 First case

22m First check valve chamber

22n Second check valve chamber

22p, 22q Opening portion

51 Selector valve

51a First open valve

51b First actuation valve

51e First check valve

51f First valve chamber

52a Second open valve

52b Second actuation valve

52e Second check valve

52f Second valve chamber

### DETAILED DESCRIPTION OF THE INVENTION

Embodiments of the present invention will be described below with reference to the attached drawings.

### Embodiment 1

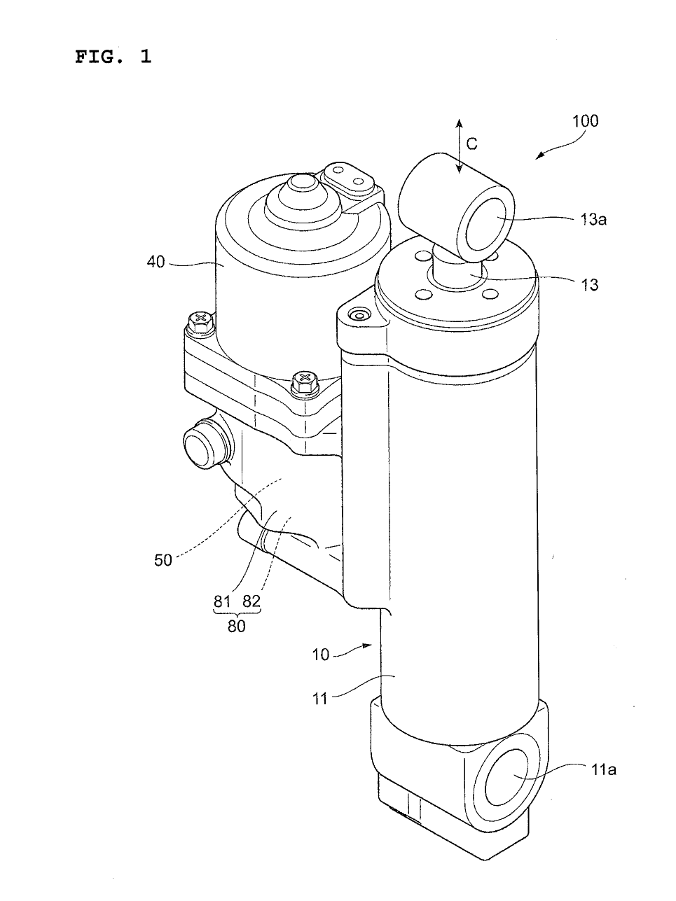

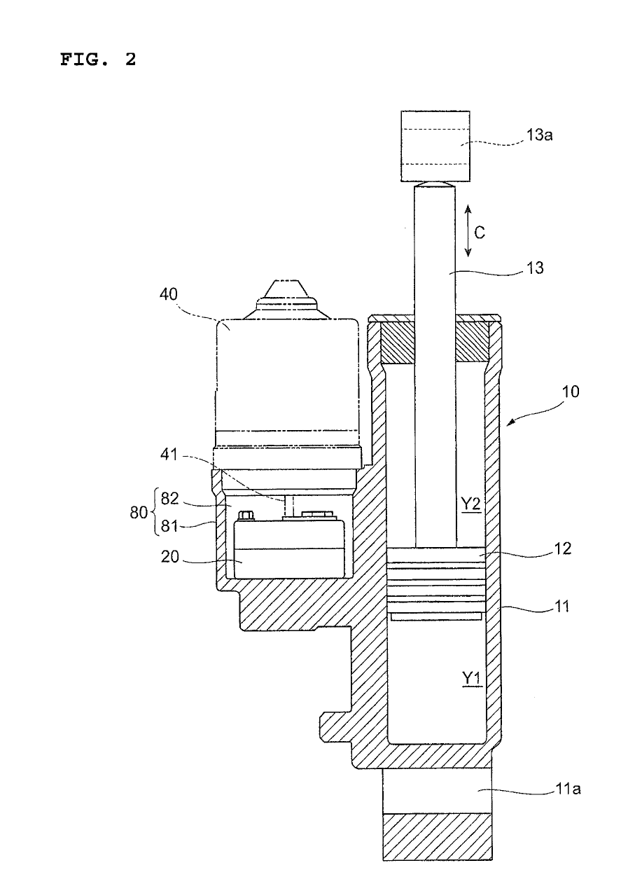

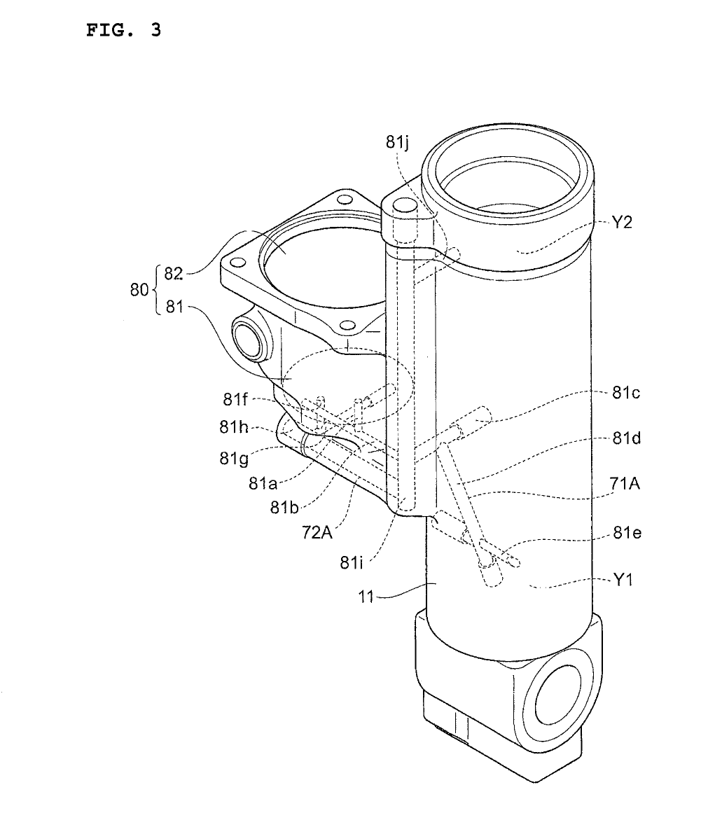

FIG. 1 is a perspective view showing the appearance of a trim/tilt apparatus 100 (an example of a hydraulic actuator) including a pump apparatus 20 according to an embodiment (Embodiment 1) of the present invention. FIG. 2 is a cross-sectional view of an important part of the trim/tilt apparatus 100. FIG. 3 is a perspective view showing a housing 81 and a cylinder 11 in the trim/tilt apparatus 100.

### General Configuration of the Trim/tilt Apparatus 100

As shown in FIG. 1 and FIG. 2, the trim/tilt apparatus 100 includes a cylinder apparatus 10 that is extended and shortened by supply and discharge of oil, an example of a hydraulic fluid, a pump apparatus 20 that delivers oil, a motor 40 that drives the pump apparatus 20, and a tank 80 in which oil is stored.

(Cylinder Apparatus 10)

As shown in FIG. 2, the cylinder apparatus 10 includes a cylinder 11 extending in the direction of an axis C, a piston 12 arranged inside the cylinder 11 and sliding along the direction of the axis C in the cylinder 11, and a piston rod 13 with the piston 12 fixed thereto at one end thereof, the piston rod 13 being displaced integrally with the piston 12 and moving forward and backward in the direction of the axis C with respect to the cylinder 11.

The cylinder apparatus 10 is internally partitioned into a first chamber Y1 and a second chamber Y2 by the piston 12. Supply of oil to the first chamber Y1 extends the cylinder apparatus 10. Supply of oil to the second chamber Y2 shortens the cylinder apparatus 10. In this case, extension of the cylinder apparatus 10 allows oil to be discharged from the second chamber Y2. Shortening of the cylinder apparatus 10 allows oil to be discharged from the first chamber Y1.

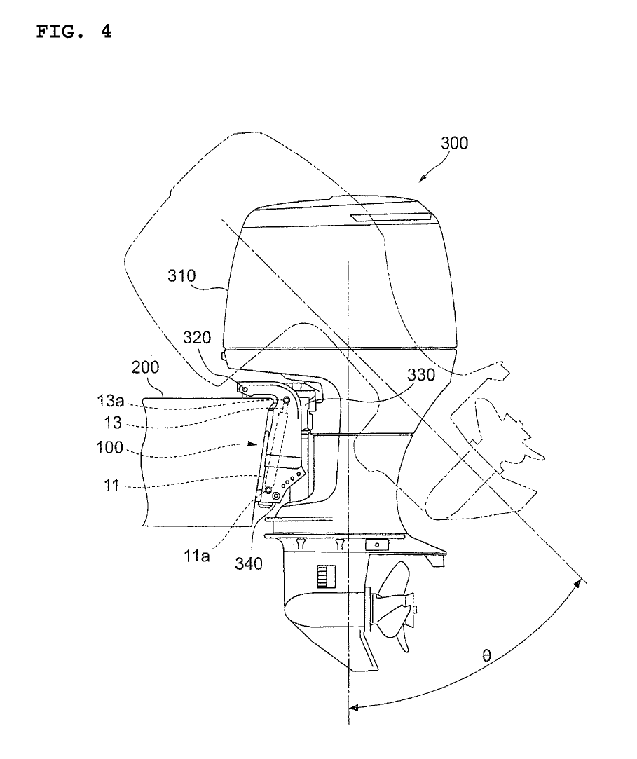

The cylinder 11 includes a pin hole 11a formed at a lower end, in FIG. 2, of the cylinder 11 and into which a pin (not shown in the drawings) for connection to a stern bracket 340 of a ship propulsion machine 300 described below (see FIG. 4 described below) is inserted. On the other hand, the piston rod 13 includes a pin hole 13a formed at an upper end, in FIG. 2, of the piston rod 13 and into which a pin (not shown in the drawings) for connection to a swivel case 330 in the ship propulsion machine 300 described below (see FIG. 4 described below) is inserted.

(Tank 80)

The tank 80 includes a housing 81 and a tank chamber 82 that is a space enclosed by the housing 81. The housing 81 is formed integrally with the cylinder 11. As shown in FIG. 3, the housing 81 and the cylinder 11 include only two channels—a part of a cylinder-side first chamber-side channel 71A and a part of a cylinder-side second chamber-side channel 72A—as channels for oil connecting the pump apparatus 20 to the first chamber Y1 and the second chamber Y2 in the cylinder apparatus 10.

The cylinder-side first chamber-side channel 71A is partly formed by connecting together a housing first hole 81a, a housing second hole 81b, a housing third hole 81c, a cylinder first hole 81d, and a cylinder second hole 81e.

The housing first hole 81a is formed to extend downward from a bottom surface of the housing 81 so as not to penetrate a bottom portion of the housing 81. The housing second hole 81b is formed to extend horizontally from a side surface of the bottom portion of the housing 81 toward the cylinder 11 so as to cross the housing first hole 81a. The housing third hole 81c is formed to extend horizontally from a side surface of a boundary portion between the housing 81 and the cylinder 11 so as to cross the housing second hole 81b at right angles. The cylinder first hole 81d is formed to extend obliquely upward from a side surface of the cylinder 11 so as to cross the housing third hole 81c at right angles. The cylinder second hole 81e is formed to extend horizontally from the side surface of the cylinder 11 so as to cross the cylinder first hole 81d and to open into the first chamber Y1.

The housing second hole 81b, the housing third hole 81c, the cylinder first hole 81d, and the cylinder second hole 81e are closed with plugs or the like (not shown in the drawings) at a portion of each hole which faces the outside of the housing 81 and at a portion of each hole which faces the outside of the cylinder 11.

The cylinder-side second chamber-side channel 72A is partly formed by connecting together a housing fourth hole 81f, a housing fifth hole 81g, a housing sixth hole 81h, a cylinder third hole 81i, and a cylinder fourth hole 81j.

The housing fourth hole 81f is formed to extend downward through the bottom surface of the housing 81 so as not to penetrate the bottom portion of the housing 81. The housing fifth hole 81g is formed to extend horizontally from the side surface of the bottom portion of the housing 81 so as to cross the housing fourth hole 81f. The housing sixth hole 81h is formed to extend horizontally from the side surface of the bottom portion of the housing 81 toward the cylinder 11 so as to cross the housing fifth hole 81g at right angles. The cylinder third hole 81i is formed to extend downward from an upper surface of the cylinder 11 so as to cross the housing sixth hole 81h at right angles. The cylinder fourth hole 81j is formed to extend obliquely downward from the second chamber Y2 so as to cross the cylinder third hole 81i.

The housing fifth hole 81g, the housing sixth hole 81h, and the cylinder third hole 81i are closed with plugs or the like (not shown in the drawings) at a portion of each hole which faces the outside of the housing 81 and at a portion of each hole which faces the outside of the cylinder 11.

The pump apparatus 20 is arranged at a bottom portion of the tank chamber 82. Oil is stored in the tank chamber 82, and thus, the pump apparatus 20 is immersed in the oil.

(Motor 40)

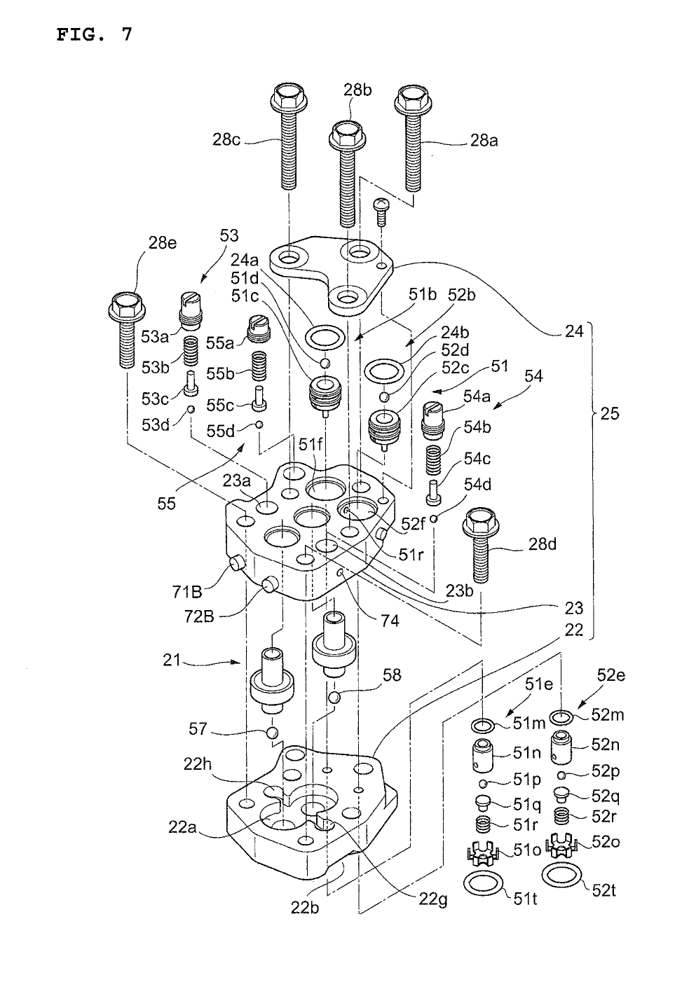

The motor 40 is placed on the housing 81 so as to close an upper opening in the tank chamber 82 in a liquid-tight manner and is fixed to the housing 81. In this state, a drive shaft 41 (see FIG. 2) of the motor 40 is coupled to a gear pump 21 (see FIG. 7 described below) of the pump apparatus 20 arranged in the tank chamber 82 so that the gear pump 21 can be driven using the motor 40.

The pump apparatus 20 will be described below.

FIG. 4 is a schematic diagram showing arrangement of a hull 200 and a ship propulsion machine 300 for which a trim/tilt apparatus 100 is used, as viewed from a side of the trim/tilt apparatus 100.

As shown in FIG. 4, the ship propulsion machine 300 includes a ship propulsion machine main body 310 that generates a propulsion force. The ship propulsion machine main body 310 has a swivel shaft (not shown in the drawings) provided in the vertical direction (up-down direction), a horizontal shaft 320 provided in the horizontal direction with respect to a water surface, the swivel case 330 in which the swivel shaft is rotationally movably housed, and the stern bracket 340 that connects the swivel case 330 to the hull 200.

The swivel case 330 is coupled to the pin hole 11a in the cylinder 11 of the trim/tilt apparatus 100 using a pin. The stern bracket 340 is coupled to a pin hole 13a in the piston rod 13 using a pin. Extension and shortening of the cylinder apparatus 10 changes the distance between the stern bracket 340 and the swivel case 330. This in turn changes the inclination θ of the ship propulsion machine 300 to the hull 200.

### Hydraulic Circuit for the Trim/tilt Apparatus 100

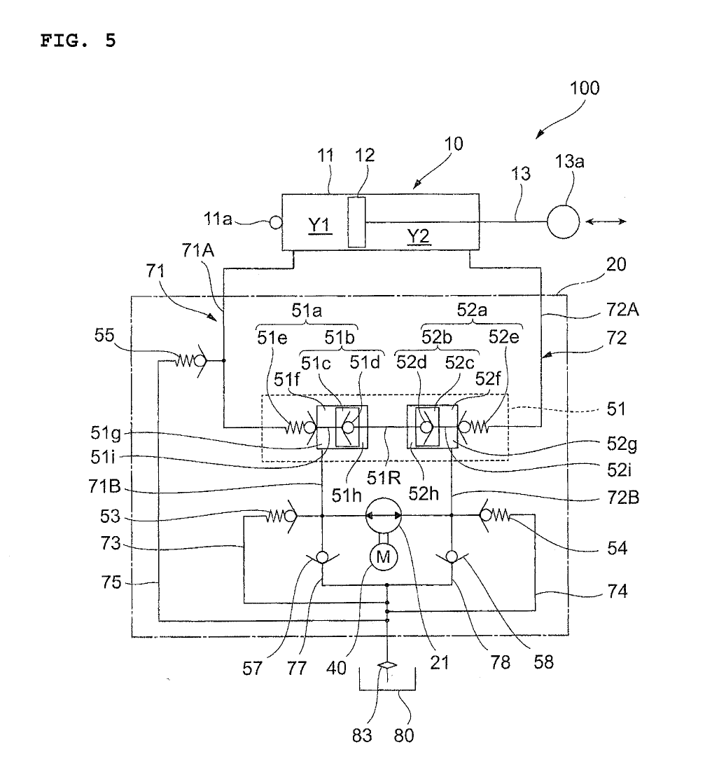

FIG. 5 is a hydraulic circuit for the trim/tilt apparatus 100. First, the hydraulic circuit for the trim/tilt apparatus 100 will be described with reference to FIG. 5.

The cylinder apparatus 10 is internally partitioned into the first chamber Y1 and the second chamber Y2 by the piston 12. Supply of oil to the first chamber Y1 extends the cylinder apparatus 10. Supply of oil to the second chamber Y2 shortens the cylinder apparatus 10. In this case, extension of the cylinder apparatus 10 allows oil to be discharged from the second chamber Y2. Shortening of the cylinder apparatus 10 allows oil to be discharged from the first chamber Y1.

The hydraulic circuit is a circuit that controls the supply and discharge of oil to and from the first chamber Y1 and the second chamber Y2.

A first chamber-side channel 71 leading to the first chamber Y1 and a second chamber-side channel 72 leading to the second chamber Y2 are formed between the cylinder apparatus 10 and a gear pump 21 provided in the pump apparatus 20 and including a pair of gears. A selector valve 51 is arranged across the first chamber-side channel 71 and the second chamber-side channel 72.

(Selector Valve 51)

The selector valve 51 switches the direction of the flow of oil toward the first chamber Y1 or toward the second chamber Y2. The selector valve 51 includes a first open valve 51a provided on the first chamber-side channel 71 and a second open valve 52a provided on the second chamber-side channel 72.

The first open valve 51a includes a first actuation valve 51b and a first check valve 51e (check valve main body) . The first actuation valve 51b includes a spool 51c (actuation valve main body) that slides through a first valve chamber 51f (actuation valve chamber), and an actuation valve ball 51d (actuation valve main body) incorporated in the spool 51c. The first valve chamber 51f is partitioned, by the spool 51c, into a main oil chamber 51g arranged to provide communication with the first check valve 51e and an opposite sub oil chamber 51h. In the first chamber-side channel 71, a pump-side first chamber-side channel 71B leading from the gear pump 21 to the first open valve 51a is connected to the main oil chamber 51g in the first open valve 51a.

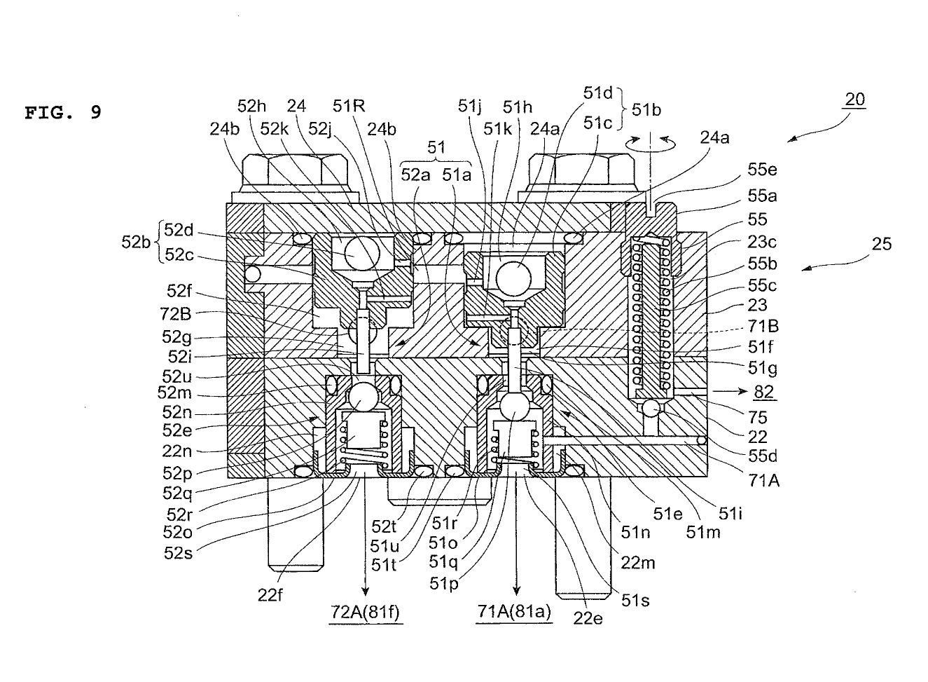

The spool 51c is provided with a projection 51i which projects toward the first check valve 51e and which pushes the first check valve 51e when the spool 51c is displaced toward the first check valve 51e side. Furthermore, the spool 51c includes: a first hole 51j to allow the main oil chamber 51g and the sub oil chamber 51h to communicate with each other; and a second hole 51k to allow the sub oil chamber 51h and a communication path 51R described below to communicate with each other, as shown in FIG. 9 described below.

The actuation valve ball 51d opens the first hole 51j when the pressure in the main oil chamber 51g is higher than the pressure in the sub oil chamber 51h. The actuation valve ball 51d closes the first hole 51j when the pressure in the main oil chamber 51g is lower than the pressure in the sub oil chamber 51h.

The second open valve 52a is configured similarly to the first open valve 51a. That is, the second open valve 52a includes a second actuation valve 52b and a second check valve 52e (check valve main body). The second actuation valve 52b includes a spool 52c (actuation valve main body) which slides through a second valve chamber 52f (actuation valve chamber) and which is provided with a projection 52i that pushes the second check valve 52e and in which a first hole 52j and a second hole 52k are formed, and an actuation valve ball 52d (actuation valve main body) incorporated in the spool 52c to open and close the first hole 52j in accordance with the pressure magnitude relation between a main oil chamber 52g and a sub oil chamber 52h. The second valve chamber 52f is partitioned, by the spool 52c, into the main oil chamber 52g arranged to provide communication with the second check valve 52e and the opposite sub oil chamber 52h. In the second chamber-side channel 72, a pump-side second chamber-side channel 72B leading from the gear pump 21 to the second open valve 52a is connected to the main oil chamber 52g in the second open valve 52a.

The sub oil chamber 51h in the first open valve 51a and the sub oil chamber 52h in the second open valve 52a are in communication with each other via the communication path 51R.

In this case, for example, the gear pump 21 is rotated forward to feed oil from the gear pump 21 to the pump-side first chamber-side channel 71B, and the oil then flows into the main oil chamber 51g in the first open valve 51a. An increase in the pressure in the main oil chamber 51g causes the first check valve 51e to be opened to allow the oil to flow from the first open valve 51a in the first chamber-side channel 71 to the cylinder-side first chamber-side channel 71A leading from the first open valve 51a to the first chamber Y1 in the cylinder apparatus 10. The oil flows into the first chamber Y1 in the cylinder apparatus 10 to push the piston 12 toward the second chamber Y2.

Furthermore, the oil having flown into the main oil chamber 51g in the first open valve 51a opens the actuation valve ball 51d in the spool 51c in the first actuation valve 51b and then flows into the sub oil chamber 51h. Then, the oil having flown into the sub oil chamber 51h passes through the communication path 51R and reaches the sub oil chamber 52h in the second open valve 52a. The actuation valve ball 52d in the second actuation valve 52b is closed, and thus, the oil in the sub oil chamber 52h pushes the spool 52c toward the main oil chamber 52g side.

The second actuation valve 52b moves toward the main oil chamber 52g side to push the second check valve 52e open, allowing the pump-side second chamber-side channel 72B to communicate with the cylinder-side second chamber-side channel 72A leading from the second open valve 52a in the second channel-side channel 72 to the second chamber Y2 in the cylinder apparatus 10. Thus, the oil in the second chamber Y2, corresponding to a side pushed by the piston 12, is discharged into the second chamber-side channel 72, and returns to the gear pump 21 through the second chamber-side channel 72.

On the other hand, a flow of oil delivered from the gear pump 21 to the pump-side second chamber-side channel 723 as a result of backward rotation of the gear pump 21 is similar to the flow of oil in the case of the forward rotation of the gear pump 21. That is, oil flows into the main oil chamber 52g in the second open valve 52a to open the second check valve 52e. The oil then flows to the cylinder-side second chamber-side channel 72A and into the second chamber Y2 in the cylinder apparatus 10 to push the piston 12 toward the first chamber Y1.

Furthermore, the oil having flown into the main oil chamber 52g in the second open valve 52a opens the actuation valve ball 52d in the spool 52c in the second actuation valve 52b and then flows into the sub oil chamber 52h. Then, the oil passes through the communication path 51R and reaches the sub oil chamber 51h in the first open valve 51a to push the spool 51c in the first actuation valve 51b toward the main oil chamber 51g side. The pushed spool 51c pushes the first check valve 51e open to allow the cylinder-side first chamber-side channel 71A and the pump-side first chamber-side channel 71B to communicate with each other. The oil in the first chamber Y1, corresponding to a side pushed by the piston 12, is discharged into the first chamber-side channel 71, and returns to the gear pump 21 through the first chamber-side channel 71.

Thus, the first actuation valve 51b and the second actuation valve 52b are displaced under the pressure of oil from the gear pump 21, and thus have a function to open the second check valve 52e or the first check valve 51e in the direction of the displacement as a result of the displacement.

The first check valve 51e and the second check valve 52e have a function to return oil from the cylinder apparatus 10 when the first check valve 51e and the second check valve 52e are opened by the displacement of the second actuation valve 52b or the first actuation valve 51b and a function to supply oil to the cylinder apparatus 10 when the first check valve 51e and the second check valve 52e are opened by pressure acting on the first valve chamber 51f or the second valve chamber 52f.

(Up Blow Valve 53)

In this case, an up blow valve 53 (first chamber-side relief valve) is connected to the pump-side first chamber-side channel 71B. The up blow valve 53 is normally closed and opened when the pressure in the pump-side first chamber-side channel 71B becomes equal to or higher than a preset pressure, to let the oil in the pump-side first chamber-side channel 71B out to a first open channel 73 leading to the tank 80.

The pressure in the pump-side first chamber-side channel 71B becomes equal to or higher than the preset pressure, for example, in the following case. That is, even after oil is supplied to the first chamber Y1 in the cylinder apparatus 10 to extend the cylinder apparatus 10 to the limit of the range of extension, the gear pump 21 keeps rotating to continuously supply oil to the first chamber-side channel 71. In this case, the up blow valve 53 is opened to return the oil supplied to the pump-side first chamber-side channel 71B to the tank 80 through the first open channel 73.

(Down Blow Valve 54)

In this case, a down blow valve 54 (second chamber-side relief valve) is connected to the pump-side second chamber-side channel 72B. The down blow valve 54 is normally closed and opened when the pressure in the pump-side second chamber-side channel 72B becomes equal to or higher than a preset pressure, to let the oil in the pump-side second chamber-side channel 72B out to a second open channel 74 leading to the tank 80.

The pressure in the pump-side second chamber- side channel 72B becomes equal to or higher than the preset pressure, for example, in the following case. That is, the pressure in the second chamber-side channel 72 increases as a result of an increase in the volume of the piston rod 13 advancing into the second chamber Y2 when the cylinder apparatus 10 shortens, or even after oil is supplied to the second chamber Y2 in the cylinder apparatus 10 to shorten the cylinder apparatus 10 to the limit of the range of shortening, the gear pump 21 keeps rotating to continuously supply oil to the second chamber-side channel 72. In this case, the down blow valve 54 is opened to return the oil supplied to the pump-side second chamber-side channel 72B to the tank 80 through the second open channel 74.

When the cylinder apparatus 10 extends or shortens, the oil in the first chamber Y1 and the oil in the second chamber Y2 mostly simply circulate via the selector valve 51 and the gear pump 21. However, as described above, the total amount of the oil in the first chamber Y1 and the oil in the second chamber Y2 changes in accordance with the amount by which the piston rod 13 advances into the second chamber Y2. Thus, if the amount of oil delivered to the first chamber Y1 or the second chamber Y2 is insufficient, an amount of oil corresponding to the insufficiency is fed from the tank 80 to the gear pump 21 through a first supply channel 77 or a second supply channel 78 with check valves 57 or 58 provided therein. Whether the first supply channel 77 or the second supply channel 78 is used to feed oil from the tank 80 to the gear pump 21 depends on the direction of rotation of the gear pump 21.

(Third Relief Valve 55)

Furthermore, a third relief valve 55 (third chamber-side relief valve) is connected to the cylinder-side first chamber-side channel 71A. The third relief valve 55 is normally closed and opened when the pressure in the cylinder-side first chamber-side channel 71A becomes equal to or higher than a preset pressure (a pressure higher than the pressure at which the up blow valve 53 is opened), to let the oil in the cylinder-side first chamber-side channel 71A out to a third open channel 75 leading to the tank 80.

The pressure in the cylinder-side first chamber-side channel 71A becomes equal to or higher than the preset pressure, for example, in the following case. That is, a load such as impact which acts in a direction in which the extended cylinder apparatus 10 shortens or the temperature of the oil rises to increase the pressure in the cylinder-side first chamber-side channel 71A. In this case, the third relief valve 55 is opened to return the oil supplied to the cylinder-side first chamber-side channel 71A to the tank 80 via the third open channel 75.

The channel leading to the tank 80 is provided with a filter 83 to prevent foreign matter and the like mixed in the oil in the tank 80 from flowing into the above-described channels.

### Pump Apparatus 20

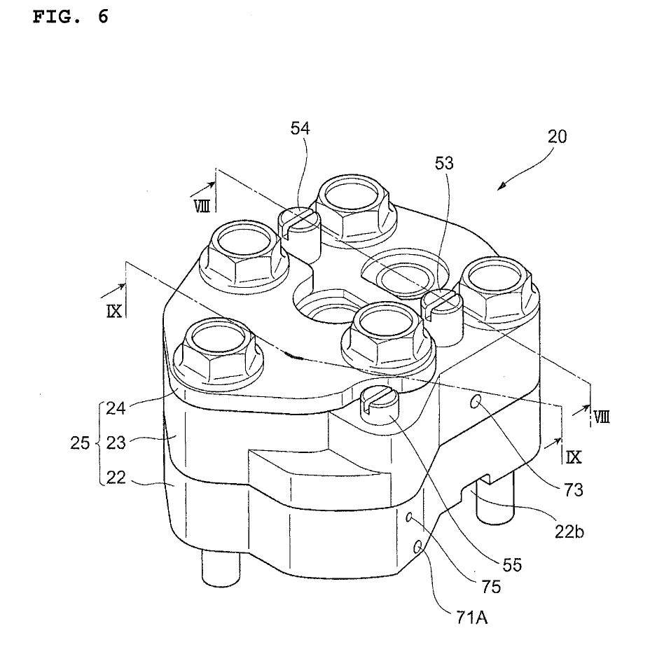

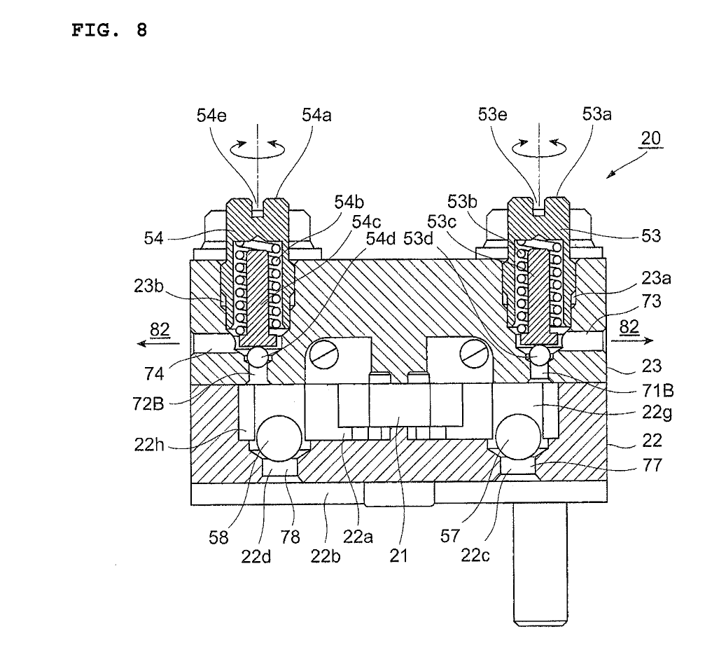

FIG. 6 is a diagram showing the appearance of the pump apparatus 20. FIG. 7 is an exploded perspective view showing that the pump apparatus 20 has been disassembled into components. FIG. 8 is a cross-sectional view showing a plane including the up blow valve 53 and the down blow valve 54. FIG. 9 is a cross-sectional view showing a plane including the first open valve 51a and second open valve 52a of the selector valve 51.

As shown in FIG. 7, the pump apparatus 20 includes a pump case 25, the gear pump 21, the selector valve 51, the up blow valve 53, the down blow valve 54, the third relief valve 55, and the two check valves 57 and 58. The pump case 25 has what is called a triple body structure in which a first case 22, a second case 23, and a cover plate 24 (cover member) are laid on top of one another in this order from the bottom of FIG. 7 and integrated together using five fastening members 28a, 28b, 28c, 28d, and 28e. Some of the five fastening members 28a, 28b, 28c, 28d, and 28e have a function to fix the pump apparatus 20 to the housing 81 (see FIG. 1).

In the pump apparatus 20, the gear pump 21 and the selector valve 51, up blow valve 53, down blow valve 54, third relief valve 55, and two check valves 57 and 58 used for the hydraulic circuit are housed inside the pump case 25 and integrated with the pump case 25 as shown in FIG. 6.

The first case 22 includes a groove 22b formed in a bottom surface of the first case 22. Furthermore, the first case 22 includes: a pump chamber 22a in which the gear pump 21 is housed; check valve chambers 22g and 22h in which the check valves 57 and 58 are housed; and a first check valve chamber 22m (see FIG. 9) and a second check valve chamber 22n in which the first check valve 51e and the second check valve 52e are housed.

The first check valve chamber 22m and the second check valve chamber 22n are formed to penetrate the first case 22 and the second case 23 in a direction in which the first case 22 and the second case 23 are laid on top of each other.

Furthermore, the second case 23 includes a first valve chamber 51f and a second valve chamber 52f. The first valve chamber 51f and the second valve chamber 52f are also each formed to penetrate the second case 23 in the direction of thickness of the second case 23. Furthermore, the second case 23 includes: an up blow valve chamber 23a in which the up blow valve 53 is housed; a down blow valve chamber 23b in which the down blow valve 54 is housed; and a third relief valve chamber 23c in which the third relief valve 55 is housed.

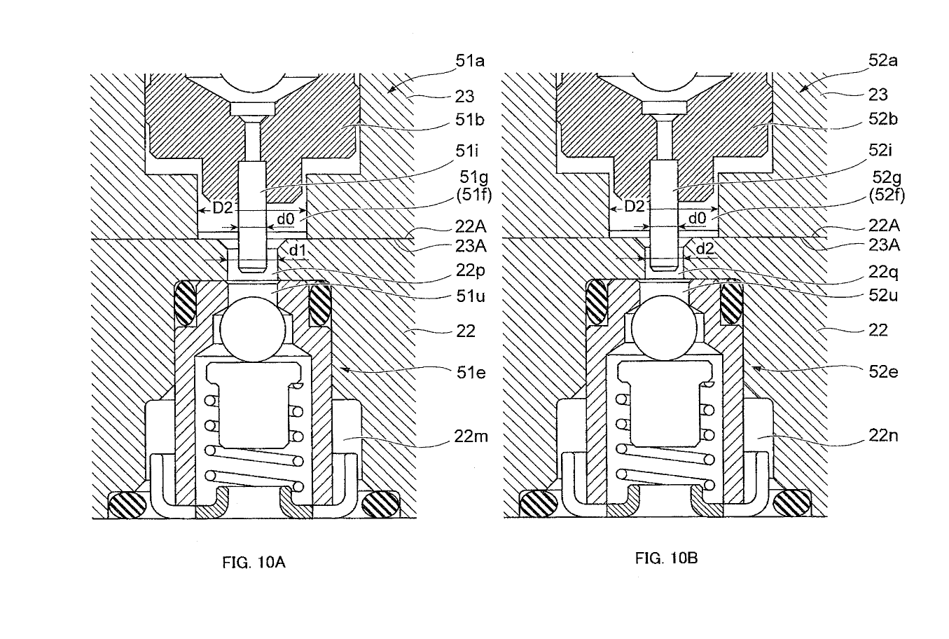

The cover plate 24 is, for example, an iron plate that closes openings 23x (see FIGS. 10A and 10B described below) of the first valve chamber 51f and the second valve chamber 52f formed in the second case 23.

As shown in FIG. 8, the gear pump 21 is arranged in the pump chamber 22a.

Furthermore, the up blow valve 53 is arranged in the up blow valve chamber 23a, and the down blow valve 54 is arranged in the down blow valve chamber 23b. The up blow valve 53 includes a valve ball 53d that opens and closes an area between the pump-side first chamber-side channel 71B leading to the check valve chamber 22g and the first open channel 73 leading to the tank chamber 82, a push pin 53c that comes into contact with the valve ball 53d from above, an adjustment screw 53a which is coaxial with the push pin 53c and which is coupled to the up blow valve chamber 23a in a threaded manner and which includes a top portion having a groove 53e for a tool formed in the top portion and projecting upward from the second case 23, and a coil spring 53b arranged between the push pin 53c and the adjustment screw 53a to exert, on the push pin 53c, an axial elastic force corresponding to the distance between the push pin 53c and the adjustment screw 53a.

In the up blow valve 53 configured as described above, the screwing-in depth of the adjustment screw 53a with respect to the second case 23 can be varied by inserting an easily available tool, for example, a flat-head screwdriver, into the groove 53e in the adjustment screw 53a projecting outward from the second case 23 and rotating the tool around the axis.

As the screwing-in depth of the adjustment screw 53a increases, the distance between the push pin 53c and the adjustment screw 53a decreases to increase the amount of initial compression of the coil spring 53b and thus the elastic force of the coil spring 53b pushing the push pin 53c downward. This in turn increases a load imposed on the pump-side first chamber-side channel 71B by the valve ball 53d, which is in contact with the push pin 53c, to close the pump-side first chamber-side channel 71B. This means an increase in a set value for the pressure in the pump-side first chamber-side channel 71B which is needed to shift to an operation of opening the closed up blow valve 53.

On the other hand, as the screwing-in depth of the adjustment screw 53a decreases, the distance between the push pin 53c and the adjustment screw 53a increases to reduce the amount of initial compression of the coil spring 53b and thus the elastic force of the coil spring 53b pushing the push pin 53c downward. This in turn reduces the load imposed on the pump-side first chamber-side channel 71B by the valve ball 53d, which is in contact with the push pin 53c, to close the pump-side first chamber-side channel 71B. This means a reduction in the set value for the pressure in the pump-side first chamber-side channel 71B which is needed to shift to an operation of opening the closed up blow valve 53.

As described above, the adjustment screw 53a of the up blow valve 53 serves as a pressure adjusting mechanism that adjusts the pressure (operating pressure) applied to actuate the up blow valve 53 (shift the up blow valve 53 from a closed state to an open state).

Like the up blow valve 53, the down blow valve 54 includes a valve ball 54d that opens and closes an area between the pump-side second chamber-side channel 72B leading to the check valve chamber 22h and the second open channel 74 leading to the tank chamber 82, a push pin 54c that comes into contact with the valve ball 54d from above, an adjustment screw 54a which is coaxial with the push pin 54c and which is coupled to the down blow valve chamber 23b in a threaded manner and which includes a top portion having a groove 54e for a tool formed in the top portion and projecting upward from the second case 23, and a coil spring 54b arranged between the push pin 54c and the adjustment screw 54a to exert, on the push pin 54c, an axial elastic force corresponding to the distance between the pushpin 54c and the adjustment screw 54a. Like the adjustment screw 53a of the up blow valve 53, the adjustment screw 54a of the down blow valve 54 serves as a pressure adjusting mechanism.

An adjusting action of the operating pressure of the down blow valve 54 is the same as the adjusting action taken by the up blow valve 53 and will thus not be described below.

The check valves 57 and 58 are arranged in the check valve chambers 22g and 22h, respectively, formed in the first case 22. The check valves 57 and 58 are placed in the check valve chambers 22g and 22h, respectively, during a step before the first case 22 and the second case 23 are laid on top of each other.

The check valve chambers 22g and 22h are in communication with holes 22c and 22d, respectively, extending downward. The holes 22c and 22d are formed to have an appropriate size at which the holes 22c and 22d are closed by the check valves 57 and 58, respectively, and are in communication with the groove 22b formed in a lower surface of the pump case 25. The pump apparatus 20 is immersed in the oil in the tank chamber 82. Thus, the groove 22b is filled with the oil, and the holes 22c and 22d correspond to the first supply channel 77 and the second supply channel 78, respectively, in the hydraulic circuit.

As shown in FIG. 9, the first actuation valve 51b and the second actuation valve 52b in the first open valve 51a and the second open valve 52a, respectively, of the selector valve 51 are arranged in a first valve chamber 51f and a second valve chamber 52f, respectively, formed in the second case 23. The first actuation valve 51b and the second actuation valve 52b are placed in the first valve chamber 51f and the second valve chamber 52f, respectively, during a step before the second case 23 and the cover plate 24 are laid on top of each other.

When the cover plate 24 is laid on top of and fixed to the second case 23 with the first actuation valve 51b placed in the first valve chamber 51f and with the second actuation valve 52b placed in the second valve chamber 52f, an upper surface of the first valve chamber 51f and an upper surface of the second valve chamber 52f are closed. At this time, O rings 24a and 24b are installed between the first valve chamber 51f and the cover plate 24 and between the second valve chamber 52f and the cover plate 24, respectively, to make the first valve chamber 51f and the second valve chamber 52f liquid-tight.

The first valve chamber 51f and the second valve chamber 52f are each formed to penetrate the second case 23 in the direction of thickness of the second case 23. Thus, the first actuation valve 51b and the second actuation valve 52b, housed in the first valve chamber 51f and the second valve chamber 52f, respectively, both slide along the direction in which the first case 22 and the second case 23 are laid on top of each other.

The second case 23 includes the communication path 51R and described above for the hydraulic circuit to connect the sub oil chamber 51h in the first valve chamber 51f to the sub oil chamber 51h in the second valve chamber 52f.

A portion of the main oil chamber 51g in the first valve chamber 51f which faces the first case 22 is formed to have an inner diameter D2, and a portion of the main oil chamber 52g in the second valve chamber 52f which faces the first case 22 is also formed to have the inner diameter D2, as shown in FIGS. 10A and 103, described below.

The first check valve chamber 22m, formed in the first case 22, is formed in an area opposite to the first valve chamber 51f when the first case 22 and the second case 23 are laid on top of each other. Furthermore, the second check valve chamber 22n, formed in the first case 22, is formed in an area opposite to the second valve chamber 52f when the first case 22 and the second case 23 are laid on top of each other.

FIG. 10A is a cross-sectional view showing the details of the first check valve chamber 22m. FIG. 10B is a cross-sectional view showing the details of the second check valve chamber 22n. As described above, the first check valve chamber 22m and the second check valve chamber 22n are formed to penetrate the first case 22 in the direction of thickness of the first case 22.

As shown in FIG. 10A, a portion 22p (hereinafter referred to as an opening portion 22p) of the first check valve chamber 22m which is open on a side where the first check valve chamber 22m faces the second case 23 faces the main oil chamber 51g in the first valve chamber 51f, formed in the second case 23. Thus, the opening portion 22p is configured as a part of a channel between the first actuation valve 51b and the first check valve 51e. The opening portion 22p is also a part of the first chamber-side channel 71 (see FIG. 5) in the first open valve 51a.

As shown in FIG. 10B, a portion 22q (hereinafter referred to as an opening portion 22q) of the second check valve chamber 22n which is open on a side of the second check valve chamber 22n facing the second case 23 faces the main oil chamber 52g in the second valve chamber 52f, formed in the second case 23. Thus, the opening portion 22q is configured as a part of a channel between the second actuation valve 52b and the second check valve 52e. The opening portion 22q is also a part of the second chamber-side channel 72 (see FIG. 5) in the second open valve 52a.

In this case, the opening portion 22p of the first check valve chamber 22m is formed to have a diameter d1 which is smaller than the inner diameter D2 of the portion of the main oil chamber 51g in the first valve chamber 51f facing the first case 22 and which is larger than the diameter d0 of the projection 51i provided in the first actuation valve 51b and which pushes the first check valve 51e (d0<d1<D2).

On the other hand, the opening portion 22q of the second check valve chamber 22n is formed to have a diameter d2 which is smaller than the inner diameter D2 of the portion of the main oil chamber 52g in the second valve chamber 52f facing the first case 22 and which is larger than the diameter d0 of the projection 52i provided in the second actuation valve 52b and which pushes the second check valve 52e (d0<d2<D2).

Moreover, the diameter d2 of the opening portion 22q of the second check valve chamber 22n is smaller than the diameter d1 of the opening portion 22p of the first check valve chamber 22m (d2<d1).

As shown in FIG. 9, the first check valve 51e includes an O ring 51m, a valve case 51n, a valve ball 51p, a push pin 51q, a coil spring 51r, a spring presser 51o, and an O ring 51t.

The valve case 51n is fitted in the first check valve chamber 22m via the O ring 51m. The valve case 51n includes a small hole 51u formed at a top portion of the valve case 51n and through which the opposite projection 51i of the first actuation valve 51b is passed. The small hole 51u has a diameter equal to the diameter d1 of the opening portion 22p of the first check valve chamber 22m.

The valve ball 51p, the push pin 51q, and the coil spring 51r are arranged in a case internal chamber 51s formed inside the valve case 51n.

The valve ball 51p is formed to be large enough to close the small hole 51u formed in the valve case 51n. The push pin 51q is arranged below the valve ball 51p so that the valve ball 51p comes into contact with an upper surface of the push pin 51q. The spring presser 51o is fitted at a bottom portion of the first check valve chamber 22m to support the valve case 51n from below. The O ring 51t is arranged around the spring presser 51o. The coil spring 51r is arranged between the push pin 51q and the spring presser 51o to exert an axial elastic force on the push pin 51q.

When the pump apparatus 20 is fixed to the housing 81 as shown in FIG. 2, an opening 22e formed in a central portion of the spring presser 51o allows the case internal chamber 51s to communicate with the housing first hole 81a formed in the housing 81. In this case, the O ring 51t ensures light-tightness between the tank chamber 82 and both the case internal chamber 51s and the housing first hole 81a.

In the first check valve 51e configured as described above, the push pin 51q lifted up by the elastic force of the coil spring 51r pushes the valve ball 51p upward, and the valve ball 51p closes the small hole 51u in the valve case 51n. This in turn closes an area between the main oil chamber 51g in the first actuation valve 51b and the case internal chamber 51s in the first check valve 51e.

At this time, when oil is supplied to the main oil chamber 51g in the first actuation valve 51b to raise the pressure in the main oil chamber 51g, the pressure in the main oil chamber 51g acts on the valve ball 51p through the small hole 51u to push the valve ball 51p downward against the elastic force of the coil spring 51r. This brings the main oil chamber 51g and the case internal chamber 51s into communication with each other to feed the oil in the main oil chamber 51g to the housing first hole 81a through the case internal chamber 51s.

Furthermore, when the oil is fed to the main oil chamber 52g in the second actuation valve 52b to raise the pressure in the main oil chamber 52g, the oil in the main oil chamber 52g flows through the second hole 52k in the spool 52c and then through the sub oil chamber 52h, the first hole 52j , and the communication path 51R in this order. The oil further flows into the sub oil chamber 51h in the first actuation valve 51b through the first hole 51j in the first actuation valve 51b.

The pressure in the sub oil chamber 51h in the first actuation valve 51b rises to cause the actuation valve ball 51d to block the communication between the sub oil chamber 51h and the main oil chamber 51g. Thus, the spool 51c in the first actuation valve 51b moves toward the main oil chamber 51g side. The movement of the spool 51c causes the projection 51i provided on the spool 51c to act on the valve ball 51p to push the valve ball 51p downward against the elastic force of the coil spring 51r. This brings the main oil chamber 51g and the case internal chamber 51s into communication with each other to return the oil having returned to the case internal chamber 51s through the housing first hole 81a, to the main oil chamber 51g.

The second check valve 52e housed in the second check valve chamber 22n is configured similarly to the first check valve 51e. The second check valve 52e includes an O ring 52m, a valve case 52n, a valve ball 52p, a push pin 52q, a coil spring 52r, a spring presser 52o, and an O ring 52t.

The valve case 52n includes a small hole 52u, which is formed at a top portion of the valve case 52n and through which the projection 52i, on the opposite side of the valve case 52n, of the second actuation valve 52b is passed. The small hole 52u has the same size as that of the small hole 51u in the valve case 51n in the first check valve 51e.

Action of the second check valve 52e is the same as the action of the first check valve 51e and will thus not be described.

With the pump apparatus 20 fixed to the housing 81 (see FIG. 2) , the opening 22f formed in a central portion of the spring presser 52o allows the case internal chamber 52s and the housing fourth hole 81f formed in the housing 81 to communicate with each other. At this time, the O ring 52t ensures light-tightness between the tank chamber 82 and both the case internal chamber 52s and the housing fourth hole 81f.

The third relief valve 55 is arranged across the first case 22 and the second case 23. Like the up blow valve 53 and the down blow valve 54, the third relief valve 55 includes a valve ball 55d that opens and closes an area between the third open channel 75 and the cylinder-side first chamber-side channel 71A leading to the case internal chamber 51s in the first check valve 51e, the push pin 55c that comes into contact with the valve ball 55d from above, an adjustment screw 55a which is coaxial with the push pin 55c and which is coupled to the second case 23 in a threaded manner and which includes a top portion having a thread groove 55e in the top portion and projecting upward from the second case 23, and a coil spring 55b arranged between the pushpin 55c and the adjustment screw 55a to exert, on the pushpin 55c, an axial elastic force corresponding to the distance between the push pin 55c and the adjustment screw 55a. Like the adjustment screw 53a of the up blow valve 53, the adjustment screw 55a of the third relief valve 55 serves as a pressure adjusting mechanism.

An adjusting action of the operating pressure of the third relief valve 55 is the same as the adjusting action taken by the up blow valve 53 or the down blow valve 54 and will thus not be described below.

### Action and Effects of the Pump Apparatus 20

In the pump apparatus 20 and trim/tilt apparatus 100 according to Embodiment 1 configured as described above, the diameter d2 of the opening portion 22q of the second check valve chamber 22n is smaller than the inner diameter D2 of the main oil chamber 52g in the second valve chamber 52f as shown in FIG. 10B. Thus, the opening portion 22q functions as the narrowed orifice in the second chamber-side channel 72.

In this case, the orifice is formed to set, during the stroke of the piston for shortening the cylinder apparatus, the pressure in a portion of the second chamber-side channel 72 closer to the gear pump 21 than the orifice (the pump-side second chamber-side channel 72B) higher than the pressure in a portion of the second chamber-side channel 72 closer to the cylinder apparatus 10 than the orifice (the cylinder-side second chamber-side channel 72A).

In other words, the opening portion 22q of the second check valve chamber 22n functions as a orifice that suppresses jerky motion of the cylinder apparatus 10 when the cylinder apparatus 10 is shortened. The pump apparatus 20 and the trim/tilt apparatus 100 according to Embodiment 1 allows jerky motion of the cylinder apparatus 10 to be suppressed when the cylinder apparatus 10 is shortened.

The pump apparatus 20 and the trim/tilt apparatus 100 according to Embodiment 1 eliminates the need to form, independently of the housing 81 and the cylinder 11, an orifice that suppresses jerky motion of the cylinder apparatus 10 when the cylinder apparatus 10 is shortened.

In this case, the opening portion 22q of the second check valve chamber 22n, functioning as an orifice, is a portion existing as a channel through which the main oil chamber 52g in the second valve chamber 52f communicates with the second check valve chamber 22n. Thus, during a machining operation for forming the opening portion 22q, by merely reducing the diameter of the opening portion 22q, the opening portion 22q can be provided with a function as the narrowed orifice. This eliminates the need for an additional machining operation for forming a narrowed orifice.

Therefore, the pump apparatus 20 and the trim/tilt apparatus 100 according to Embodiment 1 eliminate the need for a machining operation for forming a narrowed orifice, enabling a reduction in machining man-hour.

Furthermore, in the pump apparatus 20 and the trim/tilt apparatus 100 according to Embodiment 1, the second check valve chamber 22n is formed in the first case 22, the second valve chamber 52f is formed in the second case 23, and the first case 22 and the second case 23 are laid on top of each other. The opening portion 22q of the second check valve chamber 22n, functioning as a narrowed orifice, can be formed by machining the surface 22A on which the second case 23 is laid. Consequently, the opening portion 22q can be formed using an easy machining operation.

In the pump apparatus 20 and the trim/tilt apparatus 100 according to Embodiment 1, the opening portion 22p of the first check valve chamber 22m also has the diameter d1 smaller than the inner diameter D2 of the main oil chamber 51g in the first valve chamber 51f and can thus function as a narrowed orifice in the first chamber-side channel 71. However, for the pump apparatus and the hydraulic actuator according to the present invention, the provision of a narrowed orifice in the first chamber-side channel 71 is not essential. Thus, also in the pump apparatus 20 and the trim/tilt apparatus 100 according to Embodiment 1, the opening portion 22p of the first check valve chamber 22m need not be formed to have a smaller diameter than the main oil chamber 51g in the first valve chamber 51f.

In Embodiment 1, the opening portion 22q of the second check valve chamber 22n has a smaller channel area than the opening portion 22p of the first check valve chamber 22m and thus exerts a higher orifice effect (a higher effect as a narrowed orifice) than the opening portion 22p of the first check valve chamber 22m. Therefore, even if the opening portion 22p of the first check valve chamber 22m fails to exhibit a high orifice effect, the opening portion 22q of the second check valve chamber 22n can be allowed to demonstrate a relatively high orifice effect. This enables jerky motion of the cylinder apparatus 10 to be suppressed when the cylinder apparatus 10 is shortened.

Furthermore, the pump apparatus 20 and the trim/tilt apparatus 100 according to Embodiment 1 integrally include the selector valve 51, the up blow valve 53, the down blow valve 54, the third relief valve 55, the check valves 57 and 58, and the opening portion 22q of the second check valve chamber 22n, serving as a orifice, all of which are included in the hydraulic circuit connected to the cylinder apparatus 10.

Therefore, when the pump apparatus 20 has not been assembled to the cylinder apparatus 10 yet and is thus independent of the cylinder apparatus 10, it is possible to measure, in a step of measuring the performance of the gear pump 21 such as oil pumping capability, the hydraulic circuit as a whole incorporating the selector valve 51, the up blow valve 53, the down blow valve 54, the third relief valve 55, the check valves 57 and 58, and the opening portion 22q of the second check valve chamber 22n, serving as a orifice.

This enables a reduction in man-hour for performance measurements for the pump apparatus 20 and the hydraulic circuit.

Furthermore, since the pump apparatus 20 integrally includes the selector valve 51, the up blow valve 53, the down blow valve 54, the third relief valve 55, the check valves 57 and 58, and the opening portion 22q of the second check valve chamber 22n, serving as a orifice, all of which belong to the hydraulic circuit, none of the valves and orifices of the hydraulic circuit is arranged in the housing 81.

Therefore, the housing 81 according to Embodiment 1 allows the channels formed in the housing 81 (cylinder-side first chamber-side channel 71A and cylinder-side second chamber-side channel 72A) to be simplified compared to a housing in a conventional trim/tilt apparatus in which valves and orifices are arranged. This enables a reduction in portions of the channels formed in the housing 81 (cylinder-side first chamber-side channel 71A and cylinder-side second chamber-side channel 72A) which are joined together by crossing of holes providing the channels.

In the portions where the holes cross each other, burrs resulting from drilling of holes are likely to remain. The reduction in the portions where the holes cross each other allows burrs to be unlikely to remain in the channels.

The pump apparatus and the hydraulic actuator according to the present invention is not limited to the form in which the pump apparatus 20 integrally includes the selector valve 51, the up blow valve 53, the down blow valve 54, the third relief valve 55, the check valves 57 and 58, and the opening portion 22q of the second check valve chamber 22n, serving as a orifice, all of which belong to the hydraulic circuit to control the oil pressure. The valves other than the selector valve 51 may be separated from the pump apparatus 20 and provided, for example, in the housing 81.

### Embodiment 2

In the pump apparatus 20 and the trim/tilt apparatus 100 according to Embodiment 1, the opening portion 22q of the second check valve chamber 22n in the first case 22 is formed as a orifice. However, the present invention is not limited this form.

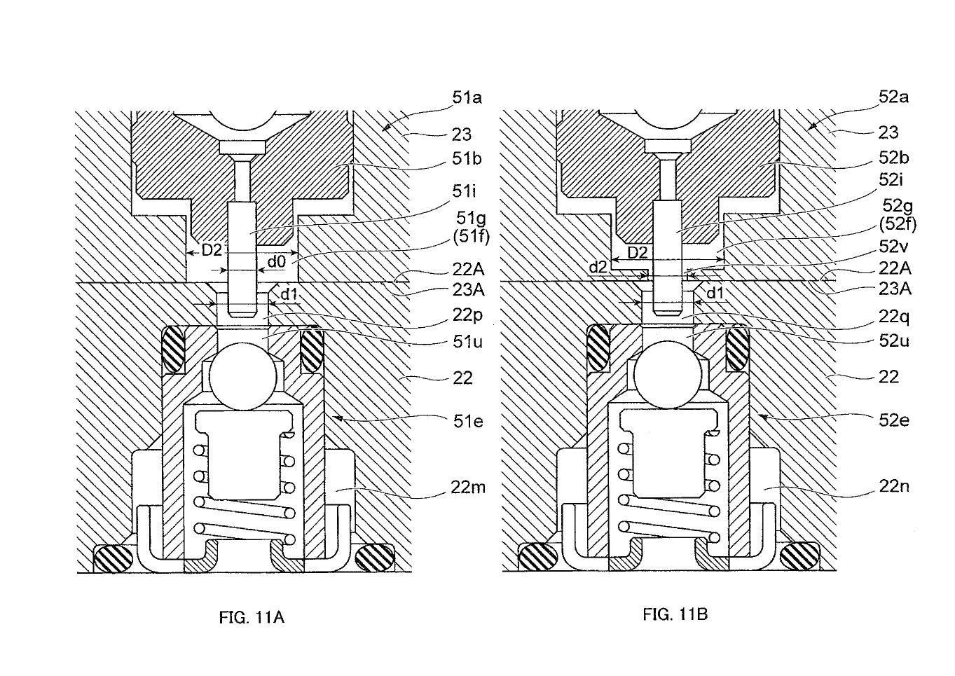

FIG. 11A is a cross-sectional view showing a portion of the first valve chamber 51f in the pump apparatus 20 and trim/tilt apparatus 100 according to another embodiment (Embodiment 2) of the present invention which portion leads to the first check valve 51e, and FIG. 11B is a cross-sectional view showing a portion of the second valve chamber 52f in the pump apparatus 20 and trim/tilt apparatus 100 according to Embodiment 2 which portion leads to the second check valve 52e. Embodiment 2 is an example in which, instead of a orifice formed in the second check valve chamber 22n in the first case 22, a orifice in the second chamber-side channel 72 is obtained by forming a portion 52v (which leads to the second check valve 52e) of the main oil chamber 52g in the second valve chamber 52f formed in the second case 23 which portion lies opposite the opening portion 22q in the second check valve chamber 22n so that the portion 52v has the diameter d2, for example, as shown in FIG. 11B.

In this case, the opening portion 22q of the second check valve chamber 22n may have the same diameter d1 as that of the opening portion 22p of the first check valve chamber 22m shown in FIG. 11A.

The pump apparatus 20 and the trim/tilt apparatus 100 according to Embodiment 2 configured as described above can exert the same effects as those of Embodiment 1.

In the pump apparatus 20 and the trim/tilt apparatus 100 according to Embodiments 1 and 2, the two relief valves, that is, the up blow valve 53 and the third relief valve 55, are provided in the first chamber-side channel 71 leading to the first chamber Y1 in the cylinder apparatus 10, as shown in FIG. 5. However, the pump apparatus and the hydraulic actuator according to the present invention are not limited to this form.

Furthermore, Embodiments 1 and 2 are applied to the trim/tilt apparatus as an example of the hydraulic actuator. However, the hydraulic actuator according to the present invention is not limited to these trim/tilt apparatuses.

What is claimed is:

1. A pump apparatus integrally comprising:
a pump that ejects a hydraulic fluid; and a selector valve that switches a direction of a flow of the hydraulic fluid to be supplied to one of a first chamber and a second chamber into which a cylinder apparatus is internally partitioned by a piston, the first chamber extending during a stroke of the piston for extending the cylinder apparatus, and the second chamber extending during a stroke of the piston for shortening the cylinder apparatus,
wherein the selective valve has, at a channel connected to the second chamber, an orifice that is narrower than a channel connected to the first chamber.

2. The pump apparatus according to claim 1, wherein the selector valve comprises an actuation valve and a check valve, and
the orifice is formed as a part of a channel between the actuation valve and the check valve.

3. The pump apparatus according to claim 2, further comprising a case housing the pump, the case comprising a first case and a second case which are laid on top of each other,
the first case comprises a check valve chamber in which a main body of the check valve is housed,
the second case comprises an actuation valve chamber in which a main body of the actuation valve is housed, and
the orifice is formed as a part of a channel through which the check valve chamber and the actuation valve chamber communicate with each other.

4. A hydraulic actuator comprising:
a cylinder apparatus internally partitioned by a piston into a first chamber extending during a stroke of the piston for extending the cylinder apparatus and a second chamber extending during a stroke of the piston for shortening the cylinder apparatus; and
a pump apparatus integrally comprising a pump that ejects a hydraulic fluid and a selector valve that switches a direction of a flow of the hydraulic fluid to be supplied to one of the first chamber and the second chamber, the selective valve comprising, at a channel connected to the second chamber, an orifice that is narrower than a channel connected to the first chamber.
